(19) United States
(12) Patent Application Publication
(10) Pub. No.: US 2011/0289484 A1
(43) Pub. Date: Nov. 24, 2011

(54) Method and System for Script Processing for Web-Based Applications

(75) Inventor: Holden R. Caine, Boulder, CO (US)

(73) Assignee: Also Energy, Boulder, CO (US)

(21) Appl. No.: 13/111,629

(22) Filed: May 19, 2011

Related U.S. Application Data
(60) Provisional application No. 61/346,400, filed on May 19, 2010.

(51) Int. Cl. G06F 9/44

(52) U.S. Cl. 717/127

(57) ABSTRACT

A system is provided for creating and deploying script for web-based applications. The user can enter and edit the contents of a script package via a web application. During development, the script package may be sent to the server to be compiled and checked for errors. A simulated run-time environment can be generated on the server that can execute the script under a set of predefined conditions. The simulated run-time environment can allow the script to be tested before deployment. The results of the compile and execution tasks are sent back to the client so that the user can debug and perfect the script. The script package may then be stored in a database for continued development and/or editing and eventual deployment to a web server.

### RELATED APPLICATIONS

This application claims priority to U.S. Provisional Patent Application No. 61/346400, filed May 19, 2010, entitled “System and Method for script Processing for Web-Based Applications,” which is incorporated herein by reference in its entirety for all that it teaches and for all purposes.

### BACKGROUND

Web-based applications that provide the ability to process data in real-time from a variety of devices can offer many options for processing that data, such as archiving, analysis, reporting and generating alerts. Due to the variety of operations that may be performed on this data, a parameterized web-based interface that satisfies all possibilities is impractical. A more flexible solution is to provide a mechanism whereby a small program or script can be entered by the operator via a web-based client, and then executed by the server at the appropriate time. Such an approach provides the ability to create solutions to specific data processing tasks without the need to deploy a customized version of the server-side application for each task.

### SUMMARY

The embodiments presented herein provide a system and method for creating and deploying script for web-based applications. In embodiments, the user enters and edits the contents of a script package via a web application. During development, the script package may be sent to the server to be compiled and checked for errors. A simulated run-time environment can be generated on the server that can execute the script under a set of predefined conditions. The simulated run-time environment can allow the script to be tested before deployment. The results of the compile and execution tasks are sent back to the client so that the user can debug and perfect the script. The script package may then be stored in a database for continued development and/or editing and eventual deployment to a web server.

Once a script has been developed and tested in the simulated run-time environment, the script may be deployed for use on a production web server. When the product web server determines that one or more scripts are available to augment the server's standard processing responsibilities, the server retrieves, from the database, and compiles the script packages. A cache may be used to store the compiled scripts to avoid unnecessary database and compiler operations and allow the compiled script to be reused.

The term “script” as used herein can refer to a program having a set of instructions. The instructions can direct an application or comprise a utility application for a program. Thus, the script is usually compiled into the syntax or code specific to the application. As explained herein, a script can be used with web-based applications, such as interactive web pages.

The term “client” or “client computer” as used herein can refer to an application or system that accesses a remote service on another computer system, known as a server, by way of a network. Client and server can run on the same machine. Using a socket a user computer, i.e., the client, may connect to a service operating on a remote system through the Internet. Servers can listen to the socket, and clients can initiate connections that a server may accept. An example client is a web browser that connects to web servers and retrieve web pages for display.

The term “server” as used herein can refer to a computer program running as a service, to serve the needs or requests of other programs, i.e., clients, which may or may not be running on the same computer. The server can also be a physical computer dedicated to running one or more such services or a software/hardware system (i.e., a software service running on a dedicated computer) such as a database server, file server, mail server, or print server. In computer networking, a server can be a program that operates as a socket listener. The term server is also often generalized to describe a host that is deployed to execute one or more programs. Generally, a server computer is a computer, or series of computers, that link other computers or electronic devices together. The servers often provide essential services across a network, either to private users inside a large organization or to public users via the Internet.

The term “web server” as used herein can refer to the hardware or the software that delivers content that can be accessed through the Internet.

The term “web application” as used herein can refer to an application that is accessed over a network. The term may also mean a computer software application that is hosted in a browser-controlled environment (e.g. a Java applet) or coded in a browser-supported language (such as JavaScript, combined with a browser-rendered markup language, like HTML) and reliant on a web browser to render the application executable.

The term “network” as used herein refers to a system used by one or more users to communicate. The network can consist of one or more session managers, feature servers, communication endpoints, etc. that allow communications, whether voice or data, between two users. A network can be any network or communication system as described in conjunction with FIGS. 10 and 11. Generally, a network can be a local area network (LAN), a wide area network (WAN), a wireless LAN, a wireless WAN, the Internet, etc. that receives and transmits messages or data between devices. A network may communicate in any format or protocol known in the art, such as, transmission control protocol/internet protocol (TCP/IP), 802.11g, 802.11n, Bluetooth, or other formats or protocols.

Hereinafter, “in communication” shall mean any electrical connection, whether wireless or wired, that allows two or more systems, components, modules, devices, etc. to exchange data, signals, or other information using any protocol or format.

The term “lexical scanner” as used herein can refer to a program that which converts a sequence of script characters into a sequence of “tokens.” The lexical scanner can process encoded information in the script into possible sequences of characters that can be contained within any of the tokens. For example, an integer token may contain any sequence of numerical digit characters. Thus, the lexical scanner can change the script language into a set of tokens or can “tokenize” the script.

The term “parser” as used herein can refer to one of the components in an interpreter or compiler, which analyzes the script, made of a sequence of tokens, to determine the scripts grammatical structure with respect to a given formal grammar. The parser can check for correct syntax and build a data structure (often some kind of parse tree, abstract syntax tree, or other hierarchical structure) implicit in the input tokens. The parser parses the source code of the script to create some form of internal representation.

The term “interpreter” or “run-time interpreter” as used herein can refer to a computer program that executes or performs instructions written in a programming language. An interpreter may be a program that executes the source code of a script directly or translates the source code of a script into some other computer language. The interpreter can perform translation, such as from a context-free grammar provided by a parser to a more application-specific language.

The term “debugger” as used herein can refer to a computer program that tests or “debugs” other programs. Debugging can mean to find and reduce or repair or defects in a script.

The term “compiler” as used herein can refer to a computer program that transforms a script written in a programming language into an application-specific computer language

The phrases “at least one”, “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine”, “calculate” and “compute,” and variations thereof, as used herein, are used interchangeably and include any type of methodology, process, mathematical operation or technique.

The term “module” refers to any known or later developed hardware, software, firmware, artificial intelligence, fuzzy logic, or combination of hardware and software that is capable of performing the functionality associated with that element. Also, while the various concepts are described in terms of exemplary embodiments, it should be appreciated that aspects can be separately claimed.

Hereinafter, “in communication” shall mean any electrical connection, whether wireless or wired, that allows two or more systems, components, modules, devices, etc. to exchange data, signals, or other information using any protocol or format.

The preceding is a simplified summary to provide an understanding of some aspects of the embodiments. This summary is neither an extensive nor exhaustive overview of the various embodiments. It is intended neither to identify key or critical elements nor to delineate the scope of the embodiments but to present selected concepts in a simplified form as an introduction to the more detailed description presented below. As will be appreciated, other embodiments are possible utilizing, alone or in combination, one or more of the features set forth above or described in detail below.

### BRIEF DESCRIPTION OF THE DRAWINGS

The present disclosure is described in conjunction with the appended Figs.:

FIG. 1 is a block diagram of an embodiment of a system for creating and executing scripts for web-based applications;

FIG. 2 is a block diagram of an embodiment of a client and server for creating a script;

FIG. 3 is a block diagram of another embodiment of a client and server for executing a script;

FIG. 4 is block diagram of another embodiment of a client and server for executing a script;

FIG. 5 is block diagram of an embodiment of a client for creating a script;

FIG. 6 is a logical block diagram of an embodiment of a script package that can be created and executed herein;

FIG. 7 is a flow diagram of an embodiment of a process for creating a script;

FIG. 8 is a flow diagram of another embodiment of a process for creating a script;

FIG. 9 is a flow diagram of an embodiment of a process for executing a script;

FIG. 10 is a block diagram of an embodiment of a computing environment operable to generate and execute scripts; and

FIG. 11 is a block diagram of an embodiment of a computer operable to generate and execute scripts.

In the appended Figs., similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The ensuing description provides embodiments only, and is not intended to limit the scope, applicability, or configuration of the invention. Rather, the ensuing description will provide those skilled in the art with an enabling description for implementing the embodiments. Various changes may be made in the function and arrangement of elements without departing from the spirit and scope of the invention as set forth in the appended claims.

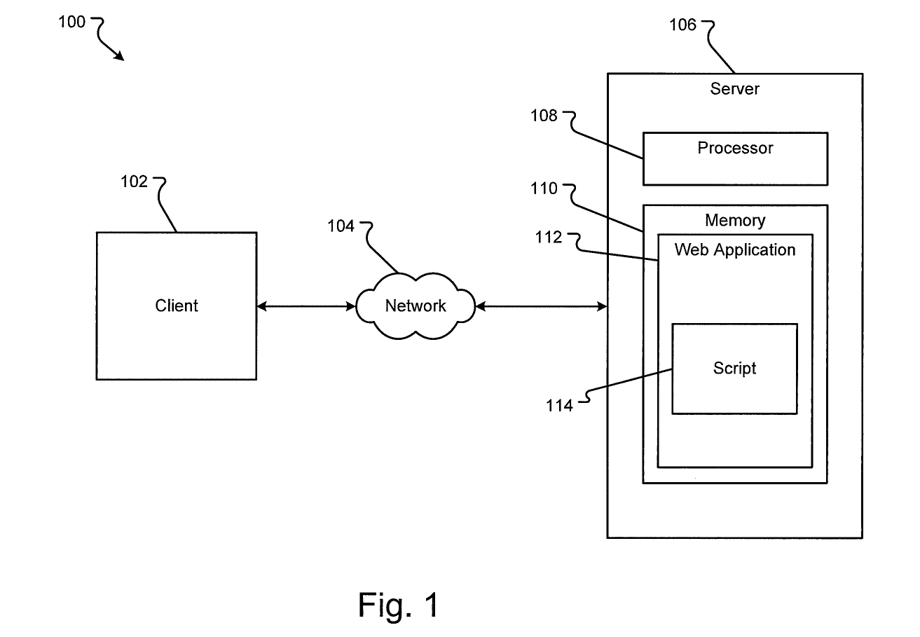

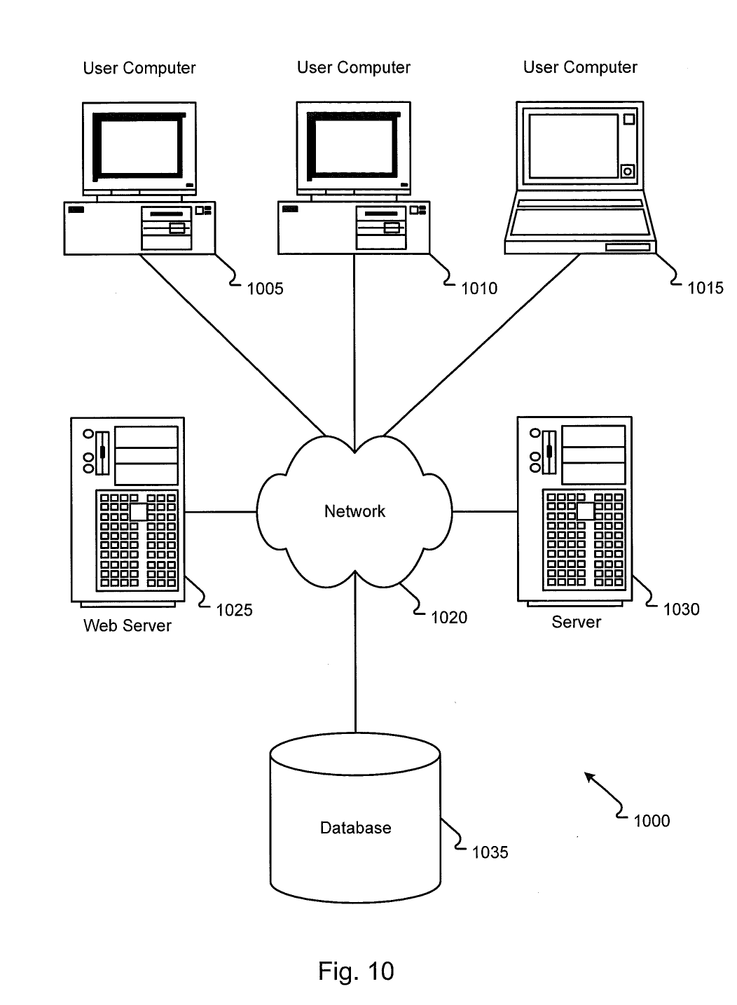

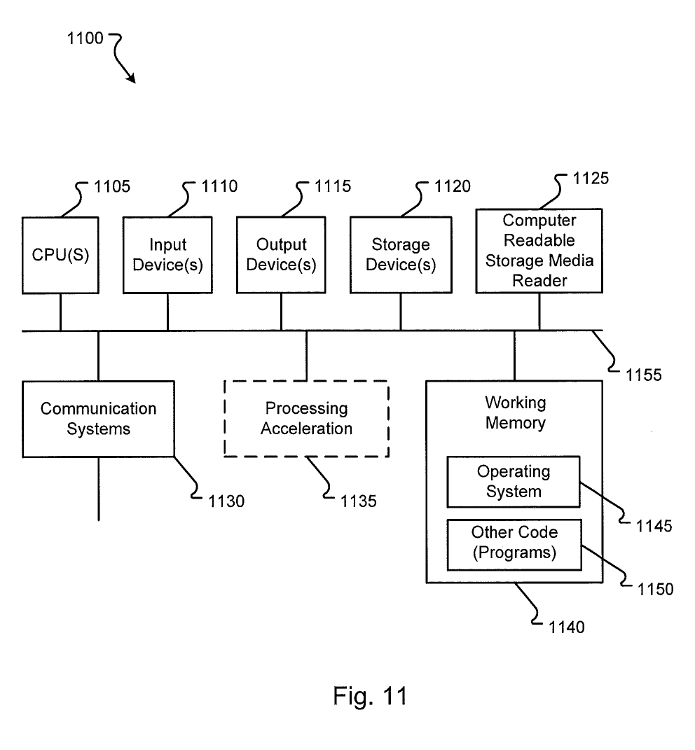

A system 100 for creating and deploying scripts is shown in FIG. 1. The devices or components in the system 100 may be hardware and/or software and may function as a computer system with components similar to those described in conjunction with FIGS. 10 and 11. In embodiments, the system 100 can include one or more of, but is not limited to, a client 102 and a server 106 connected by a network 104. The server 106 can include a processor 108 and a memory 110. Both the processor 108 and the memory 110 may be as described in conjunction with FIGS. 10 and 11. The memory 108 can store one or more software modules that can include a web application 112 and a script 114.

The web application 112 can provide web services to the client 102. To help process data, to process inputs from the client 102, or to provide the web services, the script 114 can automate or change the function of the web application 112. The script 114 may be created by the client 102 and sent to the server 106. The sever 106 may compile and test the script 114. After compiling and testing the script 114, the server 106 can send the tested script 114 back to the client 102 for further editing. After the script 114 is completed, the server 106 can store the script 114 and provide the script 114 when necessary.

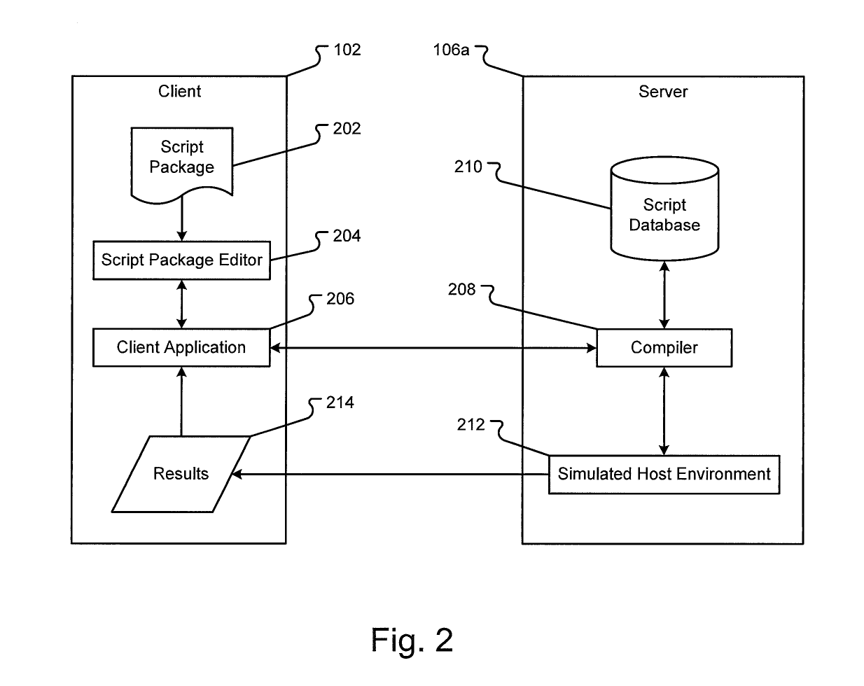

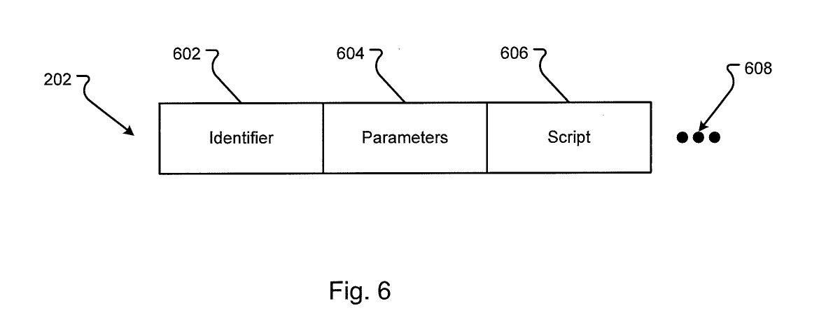

An embodiment of a client 102 and server 106 is shown in FIG. 2. The client 102 includes one or more of, but is not limited to, a script package editor 204 and a client application 206. In embodiments, the client 102 creates a script 202 in the script package editor 204. The script 202 can be a set of instructions for a web application or other application that may execute on the client 102 or the server 106. The instructions may be created in a code application or other application and provide to the script package editor 204. Thereinafter, the script package editor 204 may then edit the script and/or provide other information associated with the script. The script package may be as described in conjunction with FIG. 6. The script package editor 204 may then provide the script to a client application 206, which may include the script in a data packet and send the script to the compiler 208.

A compiler 208 can compile the script into application-specific code to be executed by a web-based application. The compiler 208 can store the compiled script in a script database 210. The script database 210 can be any database as described in conjunction with FIGS. 10 and 11. The script may be stored within the script database 210 until completed and/or deployed. Further, after the script is compiled, the compiler 208 may execute the script in a simulated host environment 212. The simulated host environment 212 provides a test environment for the script. After executing the script in simulated test environment, any results 214 from the test may be sent by the server 106 to the client application 206 of the client 102. The client may then modify the script and resend the modified script to the compiler 208 to be recompiled and retested. The process of modifying, compiling, and testing the script can continue until the client 102 is satisfied with the script. Having the compiler 208 compile and test the script at the server 106, alleviates the client 102 from needing to execute the compiler 102 or test the scripts, which requires greater processing ability and greater memory resources.

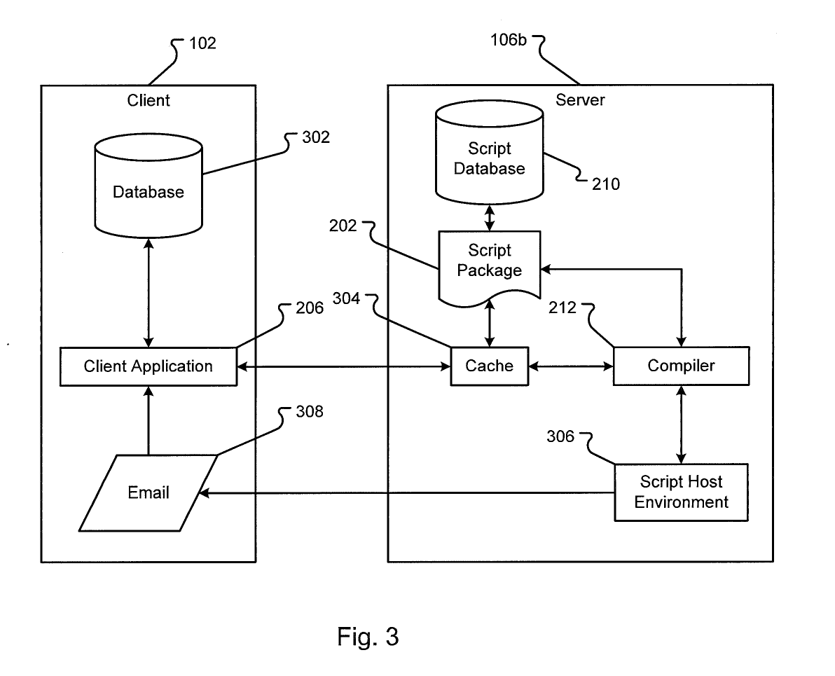

Another embodiment of a client 102 and server 106 is shown in FIG. 3. Herein, the client 102 and server 106 are operable to execute a script. The client 102 includes one or more of, but is not limited to, a client application 206 and a database 302. The database 302 may be any database as described in conjunction with FIGS. 10 and 11. In embodiments, the database 302 is operable to store data collected by or entered into the client 102. The data may be pertinent to a web-based application executed on the server 106. The client application 206 can be an application as explained in conjunction with FIG. 2. In embodiments, the client application n206 is a web-based application, for example, a web browser, that can interact with a web service executed at the server 106.

Once a script has been developed and tested in the simulated run-time environment 212, the script may be deployed for use on the server 106b. Thus, the server 106b can include one or more of but is not limited to, a script database 210, a cache 304, a compiler 212, and/or a script host environment 306. The server 106b may be as explained in conjunction with FIG. 2. In alternative embodiments, the server 106b described here with FIG. 3 is a web server that receives completed scripts from the test server 106a described in conjunction with FIG. 2.

When the server 106 determines that one or more scripts are available to augment its standard processing responsibilities, the serer 106b retrieves the script packages 202 from the database 210. The database 210 can be any database as described in conjunction with FIGS. 10 and 11. The database 210 can store completed scripts. A complete script package 202 may be sent to a cache 304 or to a compiler 212, which compiles the script for use. A cache 304 can be any storage system or medium that stores a compiled and ready script package. Thus, once compiled, the cache 304 stores the script and avoids the need for the script to be compiled on a subsequent use. The cache 304 avoids unnecessary database and compiler 212 operations since once a script is compiled, the resulting module may be reused. The compiler 212 can be as explained in conjunction with FIG. 2. The script host environment 306 may function similar to the simulated host environment 212, but the script host environment 306 actually executes the script in a run-time environment.

In an example, FIG. 3 may illustrate the use of a script for processing data uploads from a client 102, which may be a remote device. The device may be, for example, any piece of industrial equipment, such as a power meter, inverter, weather station, etc. The data may be transmitted to the server 106 by hypertext transport protocol (HTTP) or other protocol, where the server 106 processes each packet of data individually. At the remote device, processing by the client application 206 may store data into the database 302. When a script is available to process the data at the server 106b, the server 106b retrieves the script from the script database 210, compiling the script with the compiler 212, if necessary, and establishes a host run-time environment 306. The environment 306 contains a set of interfaces which allow the script access to server data, either from the uploaded HTTP request, or from other resources on the server 106b, such as files or databases. In addition, the host 306 provides a means to perform other actions, such as sending data via email 308 or file transport protocol (FTP). In a typical application, a script may simply check the uploaded data, to make sure the data is within normal parameters, and send an email 308 if a condition is detected that requires human intervention. Many other server-side processing tasks may be implemented with this approach to perform more sophisticated alert condition detection or to generate reports on a regular basis. All of these exemplary tasks may be completed with a script.

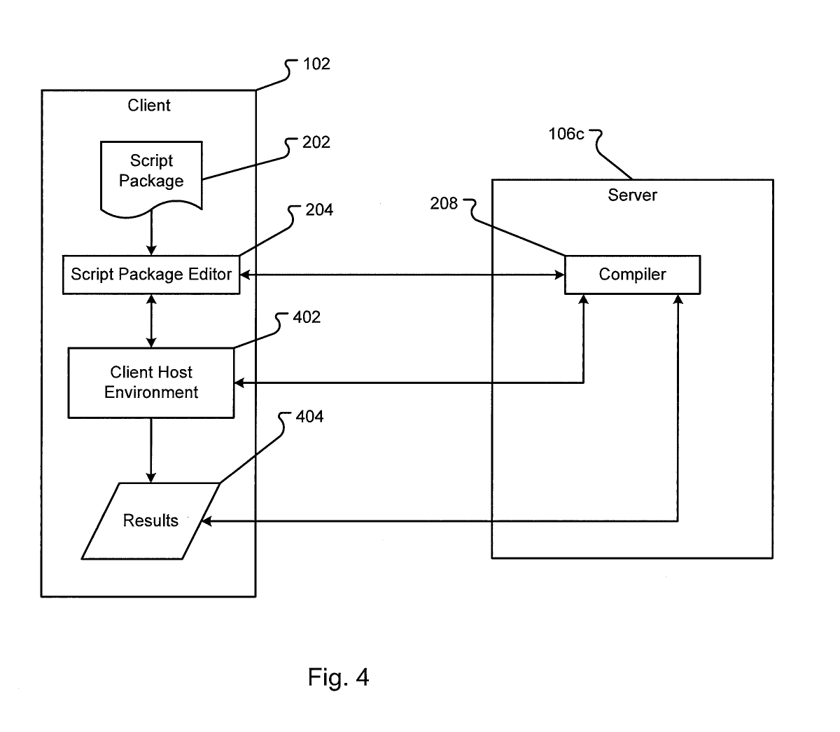

Yet another embodiment of a client 102 and server 106c is shown in FIG. 4. The components shown in FIG. 3 may be software modules executed by a processor, as explained in conjunction with FIGS. 10 and 11. Herein, the client 102 and server 106c are operable to execute a script at a client 102. The client 102 includes one or more of, but is not limited to, a script package editor 204 and a client host environment 402. The script package editor 204 and the script package 202 may be as described in conjunction with FIG. 2. The client host environment 402 is a run-time environment similar to the script host environment 306 described in conjunction with FIG. 3 but executed at the client 102. The client host environment 402 provides the necessary processing and interface capabilities for the script to execute at the client 102. The server 106c can include, but is not limited to, a compiler 208. The compiler 208 may be as explained in conjunction with FIGS. 2 and 3.

In embodiments, web-based applications generally do not have the ability to dynamically compile and execute code. A variation of the script processing system described in conjunction with FIGS. 2 and 3 allows the server 106c to provide a compile service for client web applications. The compiler 208 at the server 106c receives a script package 202 from a client-side script package editor 204. The compiler 208 returns a compiled script back to the client's client host environment 402 for execution at the client 102. The configuration in FIG. 4 allows the user to create a wide variety of custom scripts for complex operations not normally available in web-based applications. The custom scripts may be used, by way of example and not by limitation, in data processing applications for graphs, dashboards, and real-time interactive operations, which are not easily implemented on the server 106c.

Yet another embodiment of a client 102 and server 106c is shown in FIG. 4. The components shown in FIG. 4 may be software modules executed by a processor, as explained in conjunction with FIGS. 10 and 11. Herein, the client 102 interprets a script at the client 102 for testing at the client 102. The client 102 includes one or more of, but is not limited to, a script package editor 204, a lexical scanner 502, a parser 504, a run-time interpreter 506, a client application interface 508, a client application 206, and/or a debugger. The scrip package editor 204 and/or the client application 206 may be as described in conjunction with FIGS. 2 and 4. The lexical scanner 502 can tokenize a script to provide to the parser 504. The parser 504 can generate a context-free grammar for the tokens. The expressions created by the parser 504 can be provided to the run-time interpreter 506. The run-time interpreter 506 can translate the expressions and provide the translation to the client application interface 508 to execute the script for the client application 206. Thus, the client application interface 508 provides a run-time environment to execute the script for the client application 206 and to interface with the client application 206. The run-time interpreter 506 can determine errors with the execution of the script as signaled by the client application interface 508. The errors may be provided to a debugger 510 that determines errors in the script that may be causing the execution errors. The script errors can then be provided, by the debugger 510 back to the script package editor 204 for the user to fix.

For situations where the performance and capabilities of a compiled script are not necessary, an interpretive approach may be used to execute scripts locally within the client application 206. This local testing allows for a richer debug environment as the interpreter 506 can expose the internal run-time state of the script, including the execution location, call stack, and internal variables. While these capabilities may also be provided to debug a compiled script, the extensive capabilities of a general-purpose compiled language and debugger generally require a large, complex development environment that is impractical to provide in a client application. For performance reasons, a hybrid approach may be used, where the interpretive solution is used for the development of a script, while the compiled approach can be used once the script is perfected and ready for everyday use.

An embodiment of a script package 202 that may be sent to the server 106 or executed or tested at the client 102 is shown in FIG. 6. The script package 202 can include different portions or fields, which represent segments of the script package 202 where certain types of information are stored. These portions can include a one or more identifiers 602, one or more parameters 604, and a script 606. The script package 202 can include more or fewer fields that those shown in FIG. 6, as represented by ellipses 608.

An identifier 602 can be an identifier or other information that describes the context or situation for which the script 606 is intended. Thus, the identifier 602 can be a globally unique identifier (GUID), a number identifier, an alphanumeric identifier, or other type of identifier that identifies the script package 202 uniquely from other script packages. The identifier 602 context can include a web-application or process that may use the script 606. Further, the identifier 602 can include data associated with the script 606 and, if the data is received or processed, what the script 606 will function to do. As such, the identifier 602 contains any information needed by the client 102 or server 106 to retrieve and execute the script 606 at the appropriate time and with the appropriate inputs/outputs.

The one or more parameters 604 can include one or more items of data or settings that may be defined during editing or at run-time so that the script 606 may be adjusted for use with different devices or operating conditions. Thus, the parameters 604 include settings that may adjust the operation of the script 606 to the environment to which the script 606 executes. These parameters 604 can include memory addresses, port assignments for interface settings, etc.

The script 606 includes the instructions written to perform an operation. The script 606 can be any set of user-created or user-configured code that executes to complete a task. The scripts are definable by the user and differ based on the task to be completed. Generally, scripts are instructions that may be compiled and executed by a web-based application.

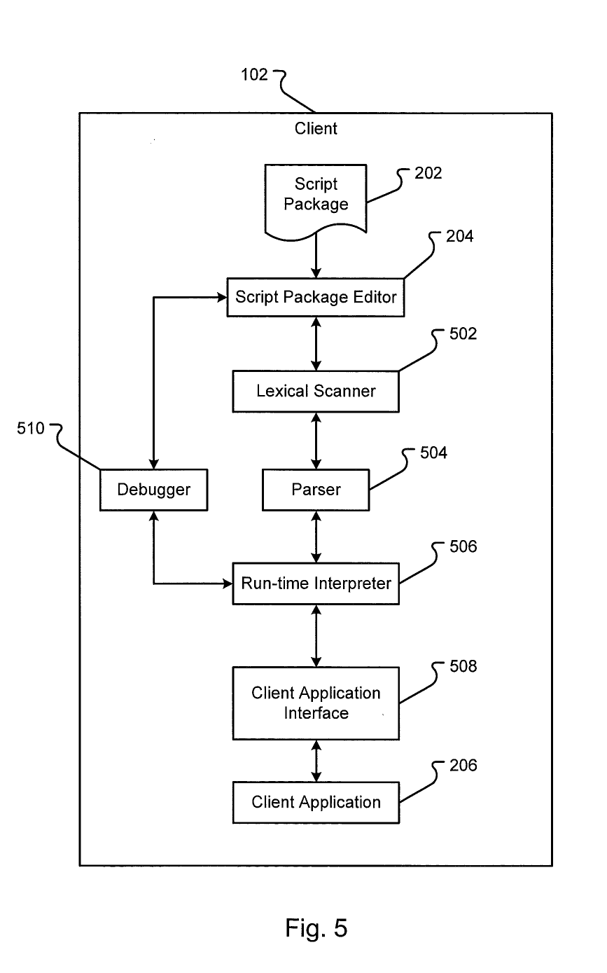

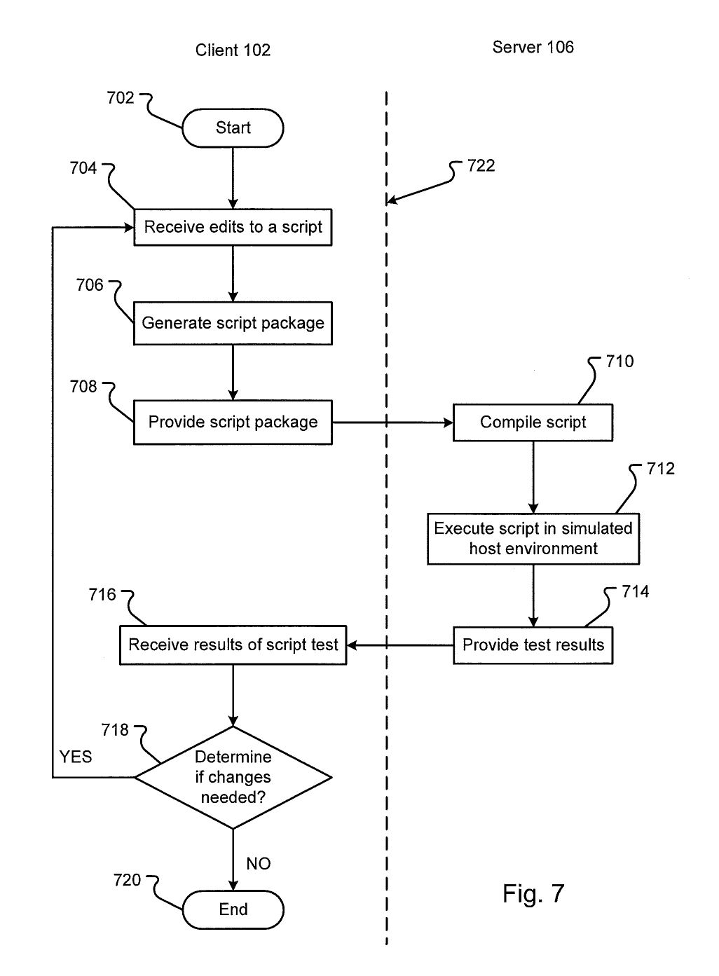

An embodiment of a method 700 for creating a script is shown in FIG. 7. While a general order for the steps of the method 700 is shown in FIG. 7. Generally, the method 700 starts with a start operation 702 and ends with an end operation 720. The method 700 shows both client-side operations and server-side operations delineated by line 722. The method 700 can include more or fewer steps or arrange the order of the steps differently than those shown in FIG. 7. The method 700 can be executed as a set of computer-executable instructions executed by a computer system and encoded or stored on a computer readable medium. Hereinafter, the method 700 shall be explained with reference to the systems, components, modules, software, data structures, etc. described in conjunction with FIGS. 1-6.

A script editor package 204 receives edits to a script 606 contained in a script package 202, in step 704. The edits can include the initial creation of the script or subsequent changes. The edits can be received through a user interface as described in conjunction with FIGS. 10 and 11. After the edits are received, the script editor package 204 can generate the script package 202, in step 706. The script editor package 204 can create the identifier 602 and the one or more parameters 604 and encapsulate the data in the script package 202. The script editor package 204 can then provide the script package 202 to a server 106, in step 708. In embodiments, the script editor package 204 provides the script package 202 to a compiler 208 at the server 106.

At the server 106, the compiler 208 compiles the script in the script package 202, in step 710. After compilation, the server 106 can store the script in a script database 210. Further, the server 106 can execute the script in a simulated host environment 212, in step 712. Results from the compilation and the test execution are generated by the server 106. The server 106 then provides the test results to the client 102, in step 714.

The test results may be received by a client application 206 or the script editor package 204, in step 716. In a user interface, the client application 206 or the script editor package 204 may provide the test results to the user. The user may then determine if changes to the script are needed. Thus, the client application 206 or the script editor package 204 determines if changes are requested by the user, in step 718. If no changes are needed, step 718 flows NO to end operation, where the compiled script may be stored locally at the client 102. However, if changes are needed, step 718 flows YES back to step 704 to receive further edits. If more edits are given, a second version of the script may be sent to the server, recompiled, retested, and results resent to the client.

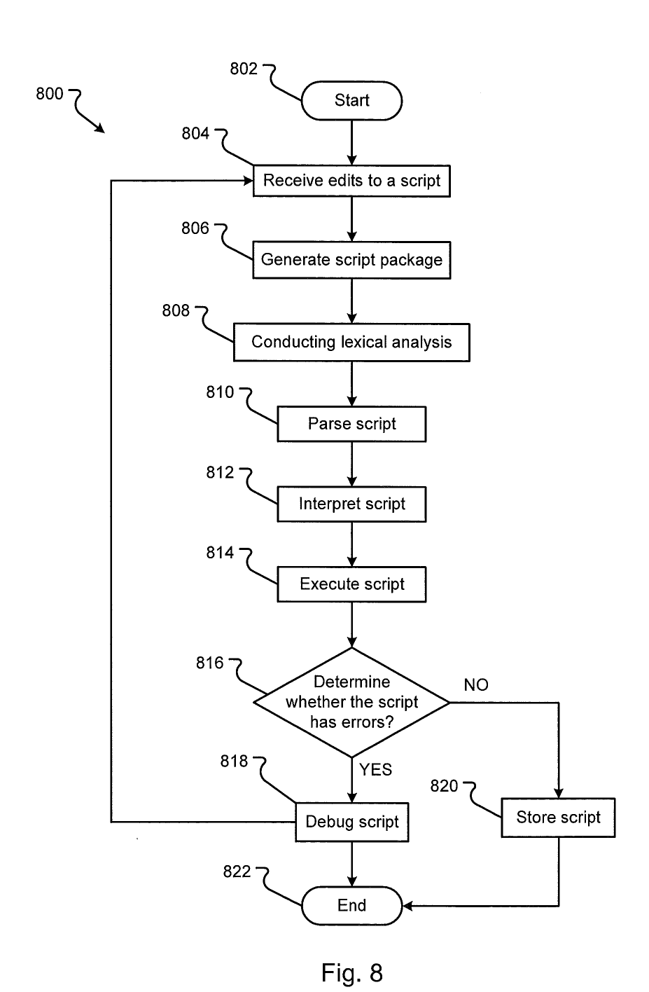

An embodiment of a method 800 for creating and testing a script at a client is shown in FIG. 8. While a general order for the steps of the method 800 is shown in FIG. 8. Generally, the method 800 starts with a start operation 802 and ends with an end operation 822. The method 800 can include more or fewer steps or arrange the order of the steps differently than those shown in FIG. 8. The method 800 can be executed as a set of computer-executable instructions executed by a computer system and encoded or stored on a computer readable medium. Hereinafter, the method 800 shall be explained with reference to the systems, components, modules, software, data structures, etc. described in conjunction with FIGS. 1-6.

A script editor package 204 receives edits to a script 606 contained in a script package 202, in step 804. The edits can include the initial creation of the script or subsequent changes. The edits can be received through a user interface as described in conjunction with FIGS. 10 and 11. After the edits are received, the script editor package 204 can generate the script package 202, in step 806. The script editor package 204 can create the identifier 602 and the one or more parameters 604 and encapsulate the data in the script package 202. The script package may then be sent to the lexical scanner 502.

The lexical scanner 502 can tokenize the script, in step 808. The tokens may then be provided to a parser 504, which parses the script, in step 810. The parsed script is then translated by a run-time interpreter 506, in step 812. The interpreted script may also be executed by the run-time interpreter 506 in a client application interface 508, in step 814. This execution can test the script for errors without compiling the script. Any results from the execution may be received by the run-time interpreter 506.

The run-time interpreter 506 can provide the results and the script to a debugger 510. The debugger can then analyze the results and the script for errors. Thus, the debugger determines if there are errors in the script, in step 816. If there are no errors, step 816 proceeds NO to step 820, where the debugger can signal the run-time interpreter 506 that the script is error free, and the run-time interpreter 506 can store the script in a database, in step 820. However, if there are errors, step 816 proceeds YES to step 818.

In step 818, the debugger 510 can determine the cause of the errors. The information about the errors may then be provided back to the script editor package 204 to provide to a user. The errors may be addressed in subsequent edits. The edited script can be retested and further edited in subsequent iterations of method 800.

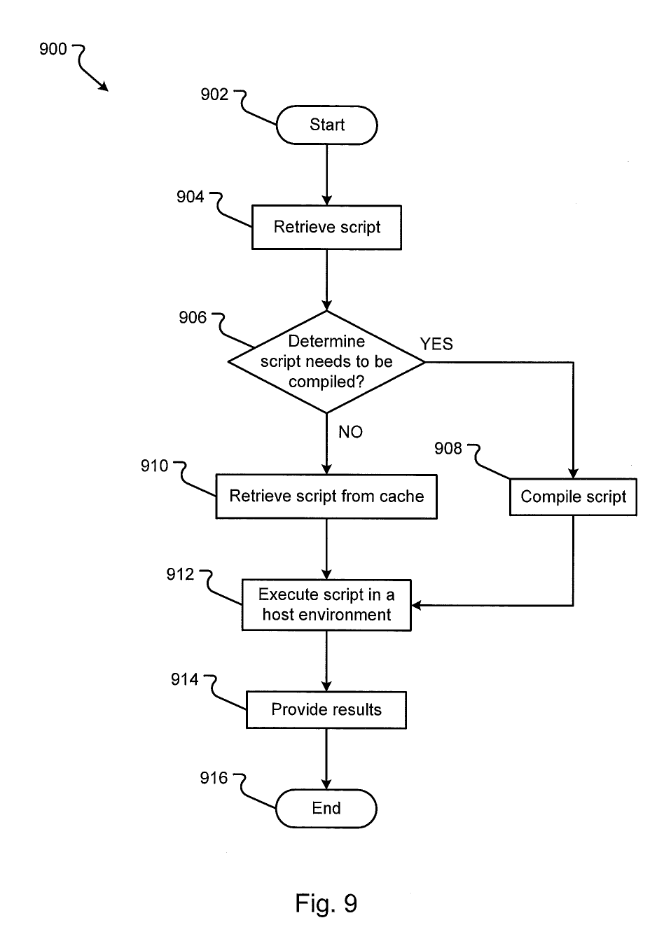

An embodiment of a method 900 for creating a script is shown in FIG. 9. While a general order for the steps of the method 900 is shown in FIG. 9. Generally, the method 900 starts with a start operation 902 and ends with an end operation 916. The method 900 can include more or fewer steps or arrange the order of the steps differently than those shown in FIG. 9. The method 900 can be executed as a set of computer-executable instructions executed by a computer system and encoded or stored on a computer readable medium. Hereinafter, the method 900 shall be explained with reference to the systems, components, modules, software, data structures, etc. described in conjunction with FIGS. 1-6.

A server 106 or client 102 may encounter a situation while running an application that has certain characteristics. The characteristics may be used to search for a script that has an identifier identifying the characteristics as associated with the script. If the script applies to the situation, the client 102 or server 106 may retrieve the script, in step 904. The script may be retrieved from a database, for example, the script database 210. After retrieving the script, the client 102 or server 106 can determine if the script needs to be compiled, in step 906. If the script needs to be compiled, step 9026 proceeds YES to step 908. If the script does not need to be compiled, step 906 proceeds NO to step 910.

In step 908, the script may be sent from the client 102 to the server 106 and received by the compiler 212. In other embodiments, the server 106 retrieves the script from the database 210 and provides the script to the compiler 212. The compiler 212 compiles the script, in step 908. The compiled script may then be cached in cache 304 for future use, without the need to be recompiled. Further, the compiled script is provided to either a script host environment 306 or a client host environment 402.

In step 910, the client 102 or the server 106 retrieves the compiled script from a cache 304. Thus, the script had been previously compiled and is stored for easy use. The retrieved script may then be provided to either a script host environment 306 or a client host environment 402. The script may then be executed in either a script host environment 306 or a client host environment 402, in step 912. If results are generated from the script execution, the results may be provided by either a script host environment 306 or a client host environment 402 to the user. In embodiments, the either a script host environment 306 or a client host environment 402 may send an email 308 to the user or the results may be available by FTP.

FIG. 10 illustrates a block diagram of a computing environment 1000 wherein the systems, devices, servers, software modules, etc. may execute. As such, the system or components described in conjunction with FIG. 10 may be commodity hardware. The computing environment 1000 includes one or more user computers 1005, 1010, and 1015. The user computers 1005, 1010, and 1015 may be general purpose personal computers (including, merely by way of example, personal computers, and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 1005, 1010, and 1015 may also have any of a variety of applications, including for example, database client and/or server applications, and web browser applications. Alternatively, the user computers 1005, 1010, and 1015 may be any other electronic device, such as a thin-client computer, Internet-enabled mobile telephone, and/or personal digital assistant, capable of communicating via a network (e.g., the network 1020 described below) and/or displaying and navigating web pages or other types of electronic documents. Although the exemplary computing environment 1000 is shown with three user computers, any number of user computers may be supported.

Computing environment 1000 further includes a network 1020. The network 1020 can be any type of network familiar to those skilled in the art that can support data communications using any of a variety of commercially-available protocols, including without limitation SIP, TCP/IP, SNA, IPX, AppleTalk, and the like. Merely by way of example, the network 1020 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 1002.11 suite of protocols, the Bluetooth™ protocol known in the art, and/or any other wireless protocol); and/or any combination of these and/or other networks. The network 1020 may be the same or similar to network 1010.

The system may also include one or more server computers 1025, 1030. One server may be a web server 1025, which may be used to process requests for web pages or other electronic documents from user computers 1005, 1010, and 1020. The web server can be running an operating system including any of those discussed above, as well as any commercially-available server operating systems. The web server 1025 can also run a variety of server applications, including SIP servers, HTTP servers, FTP servers, CGI servers, database servers, Java servers, and the like. In some instances, the web server 1025 may publish operations available operations as one or more web services.

The computing environment 1000 may also include one or more file and or/application servers 1030, which can, in addition to an operating system, include one or more applications accessible by a client running on one or more of the user computers 1005, 1010, 1015. The server(s) 1030 may be one or more general purpose computers capable of executing programs or scripts in response to the user computers 1005, 1010 and 1015. As one example, the server may execute one or more web applications. The web application may be implemented as one or more scripts or programs written in any programming language, such as Java™, C, C#™, or C++, and/or any scripting language, such as Perl, Python, or TCL, as well as combinations of any programming/scripting languages. The application server(s) 1030 may also include database servers, including without limitation those commercially available from Oracle, Microsoft, Sybase™, IBM™ and the like, which can process requests from database clients running on a user computer 1005.

The web pages created by the web application server 1030 may be forwarded to a user computer 1005 via a web server 1025. Similarly, the web server 1025 may be able to receive web page requests, web services invocations, and/or input data from a user computer 1005 and can forward the web page requests and/or input data to the web application server 1030. In further embodiments, the server 1030 may function as a file server. Although for ease of description, FIG. 10 illustrates a separate web server 1025 and file/application server 1030, those skilled in the art will recognize that the functions described with respect to servers 1025, 1030 may be performed by a single server and/or a plurality of specialized servers, depending on implementation-specific needs and parameters. The computer systems 1005, 1010, and 1015, file server 1025 and/or application server 1030 may function as the active host 102 and/or the standby host 1010.

The computing environment 1000 may also include a database 1035. The database 1035 may reside in a variety of locations. By way of example, database 1035 may reside on a storage medium local to (and/or resident in) one or more of the computers 1005, 1010, 1015, 1025, 1030. Alternatively, it may be remote from any or all of the computers 1005, 1010, 1015, 1025, 1030, and in communication (e.g., via the network 1020) with one or more of these. In a particular set of embodiments, the database 1035 may reside in a storage-area network (“SAN”) familiar to those skilled in the art. Similarly, any necessary files for performing the functions attributed to the computers 1005, 1010, 1015, 1025, 1030 may be stored locally on the respective computer and/or remotely, as appropriate. In one set of embodiments, the database 1035 may be a relational database, such as Oracle 10i™, that is adapted to store, update, and retrieve data in response to SQL-formatted commands.

FIG. 11 illustrates one embodiment of a computer system 1100 upon which the systems, devices, servers, software modules, etc. described herein may be deployed or executed. The computer system 1100 is shown comprising hardware elements that may be electrically coupled via a bus 111111. The hardware elements may include one or more central processing units (CPUs) 11011; one or more input devices 1110 (e.g., a mouse, a keyboard, etc.); and one or more output devices 11111 (e.g., a display device, a printer, etc.). The computer system 1100 may also include one or more storage devices 1120. By way of example, storage device(s) 1120 may be disk drives, optical storage devices, solid-state storage devices such as a random access memory (“RAM”) and/or a read-only memory (“ROM”), which can be programmable, flash-updateable and/or the like.

The computer system 1100 may additionally include a computer-readable storage media reader 11211; a communications system 1130 (e.g., a modem, a network card (wireless or wired), an infra-red communication device, etc.); and working memory 1140, which may include RAM and ROM devices as described above. In some embodiments, the computer system 1100 may also include a processing acceleration unit 11311, which can include a DSP, a special-purpose processor, and/or the like.

The computer-readable storage media reader 11211 can further be connected to a computer-readable storage medium, together (and, optionally, in combination with storage device(s) 1120) comprehensively representing remote, local, fixed, and/or removable storage devices plus storage media for temporarily and/or more permanently containing computer-readable information. The communications system 1130 may permit data to be exchanged with the network 420 and/or any other computer described above with respect to the computer system 1100. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 1100 may also comprise software elements, shown as being currently located within a working memory 1140, including an operating system 11411 and/or other code 11110. It should be appreciated that alternate embodiments of a computer system 1100 may have numerous variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments n have been described in detail herein, it is to be understood that the concepts may be otherwise variously embodied and employed, and that the appended claims are intended to be construed to include such variations, except as limited by the prior art.

What is claimed is:

1. A computer program product including computer executable instructions stored onto a non-transitory computer readable medium which, when executed by a processor of a computer, causes the computer to perform a method for generating a script for a web application, the instructions comprising:
instructions to receive a script package from a client;
instructions to compile a script contained in the script package;
instructions to execute the compiled script in a simulated host environment; and
instructions to provide test results associated with the execution of the compiled script to the client.

2. The computer program product as defined in claim 1, further comprising:
instructions to receive a second version of the script;
instructions to recompile the second version of the script;
instructions to re-execute the compiled second version of the script in the simulated host environment; and
instructions to provide another set of test results associated with the execution of the compiled second version of the script to the client.

3. The computer program product as defined in claim 2, wherein the script is generated at the client.

4. The computer program product as defined in claim 3, further comprising:
instructions to generate a script;
instructions to receive the test results;
instructions to provide the test results;
in response to providing the test results, instructions to receive edits to the script; and
instructions to create a second version of the script.

5. The computer program product as defined in claim 4, wherein the client determines if the script needs changes based on the test results.

6. The computer program product as defined in claim 4, wherein a completed script is stored in a script database.

7. The computer program product as defined in claim 6, wherein the script package includes an identifier, a parameter, and a script.

8. The computer program product as defined in claim 7, wherein the parameter adjusts the script for operation in a run-time environment.

9. The computer program product as defined in claim 7, wherein the identifier indentifies when to execute the script.

10. The computer program product as defined in claim 4, further comprising:
instructions to execute the compiled script in a client host environment; and
instructions to provide test results associated with the execution of the compiled script to a script package editor.

11. A method for executing a script associated with a web application, comprising:
a server, comprising a memory and processor, retrieving a script package;
the server determining if a script in the script package needs to be compiled;
if the script needs to be compiled, the server compiling the script;
if the script does not need to be compiled, the server retrieving the compiled script from a cache;
executing the compiled script associated with the web application;
providing results of the executed script.

12. The method as defined in claim 11, wherein the script is executed in a script host environment in the server.

13. The method as defined in claim 12, wherein the results are provided to a client.

14. The method as defined in claim 13, wherein the results are provided in an email.

15. The method as defined in claim 11, wherein the script is executed in a client host environment.

16. A system for executing a script associated with web application, comprising:
a client comprising:
a memory;
a processor in communication with the memory, the processor operable to execute one or more software modules, the one or more software modules comprising:
a script editor package operable to:
receive a script from a user;
edit the script;
generate a script package;
send the script package to a compiler at a server;
a client host environment operable to:
receive a compiled script from the server;
execute the compiled script;
generate results from the execution; and
provide the results to the script editor package to edit the script.

17. The content sharing device as defined in claim 16, further comprising:
a lexical scanner operable to conduct lexical analysis on the script;
a parser operable to parse the script
an interpreter operable to translate the script;
a client application interface operable to:
interface with the client side application; and
execute the translated script;
generate results from the execution to provide toe the interpreter;
a debugger operable to:
receive the results from the interpreter; and
determine errors in the script based on the results.

18. The content sharing device as defined in claim 16, wherein the script is sent to the server to be executed on the server.

19. The content sharing device as defined in claim 18, wherein client further comprises a database storing data, and wherein the data is sent to the server to be processed at the server with the script.

20. The content sharing device as defined in claim 18, wherein the server stores the script in a cache to be retrieved whenever the data is received at the server.
